(19) United States
(12) Patent Application Publication
(10) Pub. No.: US 2003/0190266 A1
(43) Pub. Date: Oct. 9, 2003

(54) Odor eliminating fiber structure having indicator

(76) Inventor: Hideyuki Tsurumi, Okayama-City (JP)

Correspondence Address: WENDEROTH, LIND & PONACK, L.L.P., 2033 K STREET N. W., SUITE 800, WASHINGTON, DC, 20006-1021, US

(21) Appl. No.: 10/330,187

(22) Filed: Dec. 30, 2002

(30) Foreign Application Priority Data
Apr. 5, 2002 (JP) 2002-103659

(51) Int. Cl. G01N 1/00; G05B 1/00

(52) U.S. Cl. 422/122; 422/120; 422/119

(57) ABSTRACT

Disclosed herein is an odor eliminating fiber structure having an indicator comprising a fiber substrate containing odor eliminating fibers, a surface thereof being visibly determined for change of odor eliminating power with a difference between a color of the fiber substrate discoloring through adsorption of a smelling gas and a color of a standard color display part.

### BACKGROUND OF THE INVENTION

1. Field of the Invention

The present invention relates to an odor eliminating fiber structure having an indicator for eliminating odor in refrigerators, trash cans, kitchen cabinets, shoe cupboards and the like.

2. Description of Related Art

Various kinds of odor eliminating materials have been proposed in order to deal with a smelling gas present in a restricted space in refrigerators, trash cans, kitchen cabinets, shoe cupboards and the like. The odor eliminating materials are demanded to have an indicator function showing change of the odor eliminating power, and odor eliminating materials having such an indicator has been also proposed.

For example, JP-A-9-614 discloses a deodorizer having an indicator function formed with a silicate deodorizer containing at least one component selected from copper powder and copper compound powder. The deodorizer changes the hue thereof to a hue that is significantly different from that before deodorization by adsorbing offensive odor components to detect the deodorizing power of the deodorizer. However, the deodorizing power of the deodorizer is ascribed to the silicate deodorizer, whereas what is used as the indicator is copper or a copper compound, and thus the indicator does not directly indicate the deodorizing power of the deodorizer itself.

JP-A-11-47247 discloses an odor eliminating composition containing (1) an odor eliminating substance capable of neutralizing an odor substance and (2) a pH indicator capable of indicating forfeiture of the odor eliminating substance, in which the odor eliminating substance contains a odor eliminating polymer containing a polymerization unit having at least one odor eliminating functional group, the polymerization unit is present in an amount of from 10 to 100% by weight of the total weight of the odor eliminating polymer, and the pH indicator is present in an amount of from 0.001 to 10 parts by weight per 100 parts by weight of the odor eliminating polymer. In this odor eliminating composition, however, the odor eliminating power is ascribed to the odor eliminating polymer, whereas the indicator is realized by the pH indicator, and thus the indicator does not directly indicate the odor eliminating power of the odor eliminating composition itself.

Furthermore, the indicators according to the two literatures simply change the color thereof but do not directly indicate the extent of decrease of the odor eliminating power, and therefore, they are insufficient for convenient determination of the replacement timing of the deodorizer or the odor eliminating composition by the user.

### SUMMARY OF THE INVENTION

The invention has been made under the circumstances, and an object thereof is to provide an odor eliminating fiber structure having an indicator capable of visibly determining change of the odor eliminating power by the user in a convenient and accurate manner through utilization of discoloration of the odor eliminating fibers themselves upon adsorbing a smelling gas.

In order to attain the object, the invention relates to, as one aspect, an odor eliminating fiber structure having an indicator comprising a fiber substrate containing odor eliminating fibers, a surface thereof being visibly determined for change of odor eliminating power with a difference between a color of the fiber substrate discoloring through adsorption of a smelling gas and a color of a standard color display part.

It is preferred in the odor eliminating fiber structure having an indicator of the invention that the color of the standard color display part provided on the surface of the fiber substrate becomes difficult to be distinguished by discoloration of the fiber substrate through adsorption of a smelling gas, and it is more preferred that a color difference between the color of the fiber substrate upon losing the odor eliminating power and the color of the standard color display part provided on the surface of the fiber substrate is 4 or more grades upon evaluation with gray scale for assessing change in color.

It is also preferred that the odor eliminating fibers contain at least one odor eliminating component selected from silver, copper and a metallic compound thereof, and a content of silver and/or copper is 0.1% by weight or more of the total fiber substrate, and it is also preferred that the odor eliminating fibers contain an odor eliminating component-containing crosslinked acrylate fibers containing at least one odor eliminating component selected from silver, copper and a metallic compound thereof, and a content of silver and/or copper is 0.1% by weight or more of the total acrylate fibers.

Furthermore, it is also preferred that one surface of the fiber substrate has an easy-sticking and easy-releasing function.

### DESCRIPTION OF THE PREFERRED EMBODIMENTS

The invention will be described in detail. The odor eliminating fibers employed in the invention are not particularly limited as far as they discolor through adsorption of a smelling gas, and are preferably ones containing a metal and/or a metallic compound discoloring through adsorption of a smelling gas as an odor eliminating component on the surface of the fibers and/or in the interior of the fibers.

The metal and/or the metallic compound is preferably at least one odor eliminating component selected from silver, copper and a metallic compound thereof, which discolor to black with sharp color change upon adsorption of a sulfur-containing gas, such as hydrogen sulfide and methylmercaptan, which is particularly disfavored as a smelling gas.

The odor eliminating fibers employed in the invention preferably contains at least one odor eliminating component selected from silver, copper and a metallic compound thereof on the surface of the fibers and/or in the interior of the fibers, and the odor eliminating fibers can be obtained, for example, by the following methods. (1) At least one odor eliminating component selected from silver, copper and a metallic compound thereof is mixed with a polymer for forming the fibers and spun to form the fibers. (2) The odor eliminating component is fixed on the surface of the fibers by using a binder. (3) An ion of the metal is bonded to an ion exchanging group owned by the fibers and then modified through chemical reaction to be contained in the fibers.

In addition to metallic silver and metallic copper, a metallic compound thereof may be contained in the odor eliminating fibers. The metallic compound is not particularly limited as far as it has an odor eliminating function, and examples thereof include an oxide, a hydroxide, a chloride, a bromide, an iodide, a carbonate, a phosphate, a chlorate, a bromate, an iodate, a sulfate, a sulfite, a thiosulfate, a thiocyanate, a pyrophosphate, a polyphosphate, a silicate, an aluminate, a tungstate, a vanadate, a molybdate, an antimonate, a benzoate and a dicarboxylate of silver or copper. Ones hardly soluble in water are preferred in order to prevent them from releasing upon water washing in the production process.

The odor eliminating fibers employed in the invention is more preferably a crosslinked acrylate fibers containing at least one odor eliminating component selected from silver, copper and a metallic compound thereof on the surface of the fibers and/or in the interior of the fibers, and an example of production of such odor eliminating component-containing crosslinked acrylate fibers by the method (3) will be described below.

Crosslinked acrylate fibers can be produced by the known method. That is, crosslinkage is introduced into acrylic fibers by a hydrazine compound. According to the process of introducing crosslinkage, the acrylic fibers become crosslinked acrylic fibers by forming crosslinkage in such a context that the acrylic fibers are not dissolved. in a solvent, and simultaneously, the nitrogen content is increased as a result. The method of the processing is not particularly limited. Such a method is preferred that the increase of the nitrogen content due to the processing is adjusted to a range of from 1.0 to 10% by weight, and even when the increase of the nitrogen content is from 0.1 to 1.0% by weight, the method can be employed as far as the method can provide an odor eliminating component-containing crosslinked acrylate fibers satisfying the characteristics of the fibers of the invention through modification to an acrylate series.

Subsequently, the crosslinked acrylic fibers are hydrolyzed with an acidic or alkaline metallic salt aqueous solution to obtain crosslinked acrylate fibers. A carboxyl group, which is one kind of an ion exchanging group, is formed through the hydrolysis, and in the case where acid is used for processing, a protonic carboxyl group is formed and in the case where an alkaline metallic salt aqueous solution is used for the processing, a metallic salt of a carboxyl group is formed. The extent of progress of the hydrolysis, i.e., the generation amount of the carboxyl group is generally from 1 to 10 mmol/g, preferably from 3 to 10 mmol/g, and more preferably from 3 to 8 mmol/g, in order to provide favorable results. In the case where the amount of the carboxyl group is less than 1 mmol/g, there are some cases where it is inefficient to contain a sufficient amount of metallic silver, metallic copper or a metallic compound thereof, and when it exceeds 10 mmol/g, there are some cases where practically satisfactory fiber properties cannot be obtained.

The carboxyl group may be in the form of a protonic acid or in the form of a metallic salt, and favorable results are liable to be obtained with the form of a protonic acid. In order to convert a carboxyl group in the form of a metallic salt to the form of a protonic acid, the method is preferably used that the fibers are immersed in various kinds of acidic aqueous solutions and then dried. Examples of the acidic aqueous solution include hydrochloric acid, acetic acid, nitric acid and sulfuric acid.

The crosslinked acrylate fibers may be further subjected to other processing in addition to the crosslinkage introducing processing and the hydrolysis processing as far as the additional processing does not impair the odor eliminating power and the color changing capability upon adsorption of a smelling gas of the odor eliminating component-containing crosslinked acrylate fibers.

The crosslinked acrylate fibers are processed with a silver and/or copper ion aqueous solution to bond the metallic ion to the ion exchanging group in the fibers. In the case where the odor eliminating component-containing crosslinked acrylate fibers containing metallic silver and/or metallic copper is produced, such fibers can be obtained by reducing the metallic ion. In the case where the odor eliminating component-containing crosslinked acrylate fibers containing a metallic compound of silver and/or copper is produced, such fibers can be obtained by further processing with an aqueous solution containing a compound capable of depositing the metallic compound through bonding with the metallic ion.

The reducing method herein is not particularly limited as far as it can reduce a metallic ion to a metal. Examples thereof include a method of reducing in a solution of a reducing agent (which gives the electron to the metallic ion), such as sodium borohydride, hydrazine, formalin, a compound containing an aldehyde group, hydrazine sulfate, hydrocyanic acid and a salt thereof, hyposulfurous acid and a salt thereof, a hyposulfite, hydrogen peroxide, Rochelle salt, glucose, a compound containing an alcohol group, and hypophosphorous acid and a salt thereof, a method of a heat treatment in an reducing atmosphere, such as hydrogen and carbon monoxide, a method of irradiation with light, and a method of combinations of these method.

Upon carrying out the reducing reaction in the solution, addition of the following additives in the reaction system is encompassed in the scope of the invention, i.e., a basic compound, such as sodium hydroxide and ammonium hydroxide; a pH adjusting agent, such as an inorganic acid and an organic acid; a buffer agent, such as an oxycarboxylic acid buffer agent, e.g., sodium citrate and sodium acetate, an inorganic acid, e.g., boric acid and carbonic acid, and an alkali salt of an organic acid and inorganic acid; an accelerating agent, such as a sulfide and a fluoride; a stabilizer, such as a chloride, a sulfide and a nitrate; and a modifying agent, such as a surface active agent. Combination use of an inert gas, such as nitrogen, argon and helium, in the heat treatment in a reducing atmosphere is also encompassed in the scope of the invention.

The compound capable of depositing the metallic compound through bonding with the metallic ion is not particularly limited, and examples thereof include a hydroxide, chlorine, bromine, iodine, carbonic acid, phosphoric acid, chloric acid, bromic acid, iodic acid, sulfuric acid, sulfurous acid, thiosulfuric acid, thiocyanic acid, pyrophosphoric acid, polyphosphoric acid, silicic acid, aluminic acid, tungstic acid, vanadic acid, molybdic acid, antimonic acid, benzoic acid and dicarboxylic acid.

The odor eliminating fibers used in the invention discolor through adsorption of a smelling gas, and it is preferred that the extent of the discoloration is distinct as much as possible. The odor eliminating compound-containing crosslinked acrylate fibers discolor to beige to black upon saturated adsorption of a sulfur series gas while the color varies depending on the content of silver and/or copper. Therefore, the fiber substrate containing the odor eliminating compound-containing crosslinked acrylate fibers preferably has such a color that is largely different from those colors in at least one of brightness, chroma saturation and hue, and can be easily distinguished from those colors before absorption of sulfur gas.

The amount of the odor eliminating component contained in the odor eliminating fibers cannot be determined unconditionally because it varies depending on the necessary odor eliminating power and the necessary extent of discoloration upon adsorption of a smelling gas, and it also varies depending on the proportion of the odor eliminating fibers in the fiber substrate. In the case where the odor eliminating component is at least one odor eliminating component selected from silver, copper and a metallic compound thereof, the content of silver and/or copper is preferably 0.1% by weight or more of the odor eliminating fibers because when it is less than 0.1% by weight, the odor eliminating power is poor, and the discoloration cannot be recognized. The content is more preferably 0.3% by weight or more. The amount of the odor eliminating agent of the fiber substrate is also preferably 0.1% by weight or more, and more preferably 0.3% by weight or more.

Examples of the external form of the fiber substrate containing the odor eliminating fibers include a string, a yarn (including wrap yarn), a filament, a fabric, a knitted fabric, a nonwoven fabric, a paper-like material, a sheet material, an accumulated material and a flocculent material (including those having a spherical form and an aggregated form). Other materials that can be used in combination with the odor eliminating fibers are also not particularly limited. Examples thereof include natural fibers, organic fibers, semisynthetic fibers and synthetic fibers, and inorganic fibers and glass fibers may also be employed depending on purposes. The material that can be used in combination is not limited to fibers, and plastics and rubber can be used, for example, by laminating with a film or embedding in a film to form a structure. Examples of fibers that are particularly preferred in the invention include natural fibers, such as wool and cotton, synthetic fibers, such as polyester, polyamide and acrylic fibers, rayon and polynosic fibers.

The mixing ratio of the odor eliminating fibers in the fiber substrate is not particularly limited and can be appropriately determined depending on the necessary odor eliminating power and the necessary extent of discoloration upon adsorption of a smelling gas. It is preferred that the odor eliminating fibers are contained in an amount of 5% by weight or more in order that the discoloration of the odor eliminating fibers is made easy to be recognized.

The indicator containing the standard color display part provided on the surface of the fiber substrate of the invention will be described. The standard color of the display part may be such a color that the change of the odor eliminating power can be visually recognized by the difference between the color of the fiber substrate having been changed through adsorption of a smelling gas and the standard color, and it is preferably a color identical or close to the color of the fiber substrate before use, or a color identical or close to the color of the fiber substrate upon losing the odor eliminating power, i.e., saturated adsorption of a smelling gas.

In the case of the former standard color, the difference in color between the display part and the fiber substrate becomes distinct through adsorption of a smelling gas, and in the case of the later standard color, the difference in color between the display part and the fiber substrate becomes difficult to be recognized through adsorption of a smelling gas. Therefore, the later standard color is preferred in order that the replacement timing can be easily recognized by the user. Furthermore, it is preferred that the color difference between the color of the fiber substrate upon losing the odor eliminating power, i.e., saturated adsorption of a smelling gas, and the standard color is 4 or more grades upon evaluation with gray scale for assessing change in color. In the case where the color difference is less than 4 grades, there is a possibility that loss of the odor eliminating power cannot be recognized depending on the users.

Example of the method for providing the display part on the surface of the fiber substrate include a method of directly printing the standard color on the fiber substrate, a method of attaching or sewing a paper, a cloth or a film having the standard color applied thereon to the fiber substrate, and a method of doing embroidery on the fiber substrate.

The printing method may be such a method that the standard color can be printed on the surface of the fiber substrate, and the ordinary printing methods, such as screen printing and gravure printing, can be employed. It is preferred to use a pigment in order to prevent inhibition of the smelling gas adsorption power as much as possible. Similarly, in the other methods, if the display is carried out with a film, a film having gas permeability is preferably used in order to prevent inhibition of the smelling gas adsorption power as much as possible.

It is also preferred in the odor eliminating fiber structure having an indicator of the invention that a back surface of the fiber substrate has an easy-sticking and easy-releasing function. The easy-sticking and easy-releasing function referred herein means a function that when the substrate is intended to be attached, it can be easily attached, but when it is intended to be released, it can be easily released. By making the function, the odor eliminating fiber structure can be placed on a location that does not disturb storage, e.g., a side face and a ceiling of refrigerators, trash cans, kitchen cabinets, shoe cupboards and the like, and also it can be released easily and a sticking agent does not remain thereon to maintain cleanness. The method of making the easy-sticking and easy-releasing function is not particularly limited, and examples thereof include a method of coating a composition exhibiting the easy-sticking and easy-releasing function on one surface of the fiber substrate, and a method of attaching an adhesive surface of a film that has the easy-sticking and easy-releasing function on one surface and adhesiveness on the other surface to the fiber substrate.

The odor eliminating fibers contained in the fiber substrate of the odor eliminating fiber structure having an indicator of the invention discolors through adsorption of a smelling gas, and as a result, it appears that the total fiber substrate discolors. Due to the discoloration, a difference occurs from the standard color that does substantially not discolor. The occurrence of the color difference becomes an indicator for the odor eliminating power of the odor eliminating fiber structure of the invention. In the case where the standard color is close to the color of the odor eliminating fibers upon saturated adsorption of a smelling gas, the color difference from the fiber substrate becomes difficult to be recognized to provide a more convenient indicator. The user can easily and accurately determine the change of the odor eliminating power and the replacement timing.

### EXAMPLES

The invention will be described in more detail with reference to the following examples. All parts and percents referred in the examples are based on weight unless otherwise indicated. The evaluation conditions and the evaluation method in the examples are as follows.

(1) Odor Eliminating Power (%)

An odor eliminating fiber structure having no easy-sticking and easy-releasing function was dried and adjusted for temperature and relative humidity to 20° C. and 65%, and it was sealed in Tedlar Bag (polyvinyl fluoride film bag), followed by deairing. 1.5 Lt of air having a temperature of 20° C. and a relative humidity of 65% was injected therein, and an appropriate amount (about ¼ of the saturated adsorption amount) of a hydrogen sulfide gas was injected therein. The assembly was allowed to stand under the foregoing conditions. After 2 hours, the visibility of the display part was evaluated with the following standard, and simultaneously, the gas concentration in the Tedlar Bag was measured with a detecting tube to calculate the gas adsorption amount (A g/g). The operation was repeated, and the sum of the gas adsorption amounts until the decreasing rate of the gas concentration in the Tedlar Bag becomes 5% or less was designated as a saturated gas adsorption amount (B g/g), whereby the odor eliminating power at the respective measurements were calculated by the following equation.

Odor eliminating power (%)=(B−A)/B×100

(2) Visibility of Display Part

The evaluation standard of the visibility of the color of the display part on the surface of the fiber substrate of the odor eliminating fiber structure was as follows.

1: The display part was substantially not visible.

2: The display part was slightly visible.

3: The display part was visible.

4: The display part was distinctly visible.

(3) Color Difference

The odor eliminating fiber structure having a display part that became difficult to be recognized through adsorption of a smelling gas was evaluated for color difference. The color difference between the color of the fiber substrate of the odor eliminating fiber structure with a smelling gas saturatedly adsorbed and the standard color display part was evaluated with the naked eye with gray scale for assessing change in color.

### Example 1

Ten part of an acrylonitrile polymer containing 90% by weight of acrylonitrile and 10% by weight of vinyl acetate (limited viscosity in dimethylformamide at 30° C. [η]:1.2) was dissolved in 90 parts of an aqueous solution of 48% sodium thiocyanate to form a spinning solution, which was then subjected to spinning and stretching (total stretching ratio: 10 times) according to the ordinary methods and then subjected to drying and a heat and humidity treatment under an atmosphere of (dry-bulb/wet-bulb)=120° C./60° C. to obtain raw material fibers having a single fiber fineness of 0.9 dtex.

The raw material fibers were subjected to a crosslinkage introducing processing in an aqueous solution of hydrazine hydrate of a concentration of 20% by weight at 98° C. for 5 hours, followed by washing. The fibers were then subjected to a processing in an aqueous solution of nitric acid of a concentration of 3% by weight at 90° C. for 2 hours. Subsequently, the fibers were subjected to a hydrolysis processing in an aqueous solution of sodium hydroxide of a concentration of 3% by weight at 90° C. for 2 hours, followed by washing with pure water. The fibers were then subjected to a processing in an aqueous solution of nitric acid of a concentration of 5% by weight at 60° C. for 0.5 hour to obtain crosslinked acrylate fibers (fibers 1) having a protonic carboxyl group in an amount of 5.5 mmol/g.

The crosslinked acrylate fibers (fibers 1) were added to a 0.1% silver nitrate aqueous solution with a bath ratio of 1/20 to effect an ion exchanging reaction at 70° C. for 30 minutes, followed by washing, dewatering and drying, to obtain ion exchanged fibers. The ion exchanged fibers were added to an aqueous solution adjusted to pH 12.5 with caustic soda to effect processing at 80° C. for 30 minutes. As a result, odor eliminating fibers (fibers 2) containing 1.0% of silver were obtained. The content of metals was measured in such a manner that the fibers were subjected to wet decomposition in a thick, mixed acid solution of nitric acid, sulfuric acid and perchloric acid, and the content of metals was measured by the atomic absorption method.

Fifty percent by weight of the odor eliminating fibers (fibers 2), 20% by weight of acrylic fibers (1.7 dtex) and 30% by weight of polyester heat-fusible fibers (4.4 dtex) were blended and subjected to carding and needle punching, followed by a heat treatment at 140° C., to produce a nonwoven fabric (fiber substrate A) having a basis weight of 170 g/m². The color of the fiber substrate A was light beige.

A fabric having a color that was substantially the same as the color of the fiber substrate A as the standard color display part was sewed on a part of the surface of the fiber substrate A to obtain an odor eliminating fiber structure having an indicator of Example 1. Two g of the dried fiber structure was evaluated for odor eliminating power and visibility of the display part at that odor eliminating power. The results are shown in Table 1. A hydrogen sulfide gas in the measurement of odor eliminating power was injected to make a gas concentration (initial concentration) of 60 ppm.

### Comparative Example 1

Seventy percent by weight of acrylic fibers (1.7 dtex) and 30% by weight of polyester heat-fusible fibers (4.4 dtex) were blended, but no odor eliminating fibers (fibers 2) were used, and subjected to carding and needle punching, followed by a heat treatment at 140° C., to produce a nonwoven fabric (fiber substrate B) having a basis weight of 170 g/m². The color of the fiber substrate B was white. A fabric having substantially the same color was sewed on a part of the surface of the fiber substrate B to obtain a fiber structure of Comparative Example 1. The fiber structure of Comparative Example 1 was evaluated in the same manner as in Example 1, but it does not adsorb hydrogen sulfide, and no discoloration occurred.

### Example 2

A pigment having a color that was substantially the same as the color of the fiber substrate A with hydrogen sulfide saturatedly adsorbed was printed by the ordinary screen printing method on a part of the surface of the fiber substrate A before gas adsorption to form a figure display as the standard color display part, whereby an odor eliminating fiber structure having an indicator of Example 2 was obtained. The fiber structure was evaluated in the same manner as in Example 1. The results of evaluation are shown in Table 1.

### Example 3

A nonwoven fabric (fiber substrate C) was obtained in the same manner as in Example 1 except that a 0.25% copper sulfate aqueous solution instead of the 0.1% silver nitrate aqueous solution was used. The color of the fiber substrate C was light dark green. A figure display was printed on the fiber substrate C in the same manner as in Example 2 to obtain an odor eliminating fiber structure having an indicator of Example 3. The odor eliminating fibers (fibers 3) of Example 3 contained 2.5% of copper. The fiber structure was evaluated in the same manner as in Example 1 except that 1 g of the fiber structure was used. The results of evaluation are shown in Table 1.

### Example 4

Odor eliminating fibers (fibers 4) containing 20% of silver were obtained in the same manner as in Example 1 except that the concentration of the silver nitrate aqueous solution was 5%, and the processing time was 180 minutes. A fiber substrate D was obtained in the same manner as in Example 1 except that 20% by weight of the odor eliminating fibers (fibers 4) and 50% by weight of the acrylic fibers were used. The color of the fiber substrate D was beige. A figure display was printed on the fiber substrate D in the same manner as in Example 2 to obtain an odor eliminating fiber structure having an indicator of Example 4. The same evaluation as in Example 1 was carried out by using 1 g of the fiber structure with the initial concentration of hydrogen sulfide of 250 ppm. The results of evaluation are shown in Table 1.

### Example 5

A fiber substrate E was obtained in the same manner as in Example 1 except that the concentration of the silver nitrate aqueous solution was 0.03%, and the processing time was 10 minutes. The color of the fiber substrate E was light beige. A figure display was printed on the fiber substrate E in the same manner as in Example 2 to obtain an odor eliminating fiber structure having an indicator of Example 5. The odor eliminating fibers (fibers 5) of Example 5 contained 0.3% of silver. The fiber structure was evaluated in the same manner as in Example 1 except that 4 g of the fiber structure was used. The results of evaluation are shown in Table 1.

TABLE 1

| | Color of fiber substrate | | Visibility of display part | | | | | Color difference on |
|---|---|---|---|---|---|---|---|---|
| | Odor eliminating power (%) | | Odor eliminating power (%) | | | | | saturated adsorption |
| | 100 | 0 | 100 | 75 | 50 | 30 | 0 | (grade) |
| Example 1 | light beige | light umber | 1 | 1 | 2 | 3 | 4 | — |
| Comparative | — | white | no odor eliminating power | | | | | — |
| Example 1 | | | | | | | | |
| Example 2 | light beige | light umber | 4 | 3 | 3 | 2 | 1 | 4-5 |
| Example 3 | light dark green | brown | 4 | 3 | 2 | 2 | 1 | 4-5 |
| Example 4 | Beige | umber | 4 | 3 | 2 | 2-1 | 1 | 4-5 |
| Example 5 | very light beige | beige | 3 | 3 | 2 | 2 | 1 | 4-5 |

In the odor eliminating fiber structure of Example 1, the display part became visible through adsorption of the gas, and finally (upon saturated adsorption), the display part could be clearly recognized. In Examples 2 to 5, through the absorption of the gas the display part became difficult to be distinguished from the other part, and finally (upon saturated adsorption), the display part was substantially invisible. In Example 4 where the amount of silver in the odor eliminating fiber structure was large, the display part approached the color upon saturated adsorption in the early stage, and in Example 5 where the amount of silver in the odor eliminating fiber structure was small, the difference between the color upon saturated adsorption and the color before adsorption was small. In both the cases, the display part was somewhat difficult to be viewed at a time where the odor eliminating power was 30%, but the fiber structures were in a level that they are sufficient for practical use. The fiber structure of Comparative Example 1 having no odor eliminating power suffered no color change.

### Example 6

Acrylform FX8802S (produced by E-TEC Co., Ltd.) as a composition exhibiting an easy-sticking and easy-releasing function was coated on the back surface of the odor eliminating fiber structure of Example 2 and dried at 170° C. for 10 minutes to obtain an odor eliminating fiber structure having an indicator with an easy-sticking and easy-releasing function of Example 6. The odor eliminating fiber structure was easily stuck on a wall surface of a refrigerator and could be easily released therefrom without any sticking agent remaining.

The odor eliminating fiber structure having an indicator of the invention has such an indicator that utilizes the difference between the color after the discoloration of the odor eliminating fibers themselves upon adsorbing a smelling gas and the standard color of display part that does substantially not discolor. The odor eliminating fiber structure having an indicator of the invention can be advantageously used as an odor eliminating fiber structure having an indicator, which eliminates odor in refrigerators, trash cans, kitchen cabinets, shoe cupboards and the like and which can be easily and accurately determined for change of the odor eliminating power and replacement timing by the user.

What is claimed is:

1. An odor eliminating fiber structure having an indicator comprising a fiber substrate containing odor eliminating fibers, a surface thereof being visibly determined for change of odor eliminating power with a difference between a color of the fiber substrate discoloring through adsorption of a smelling gas and a color of a standard color display part.

2. An odor eliminating fiber structure having an indicator as claimed in claim 1, wherein the color of the standard color display part provided on the surface of the fiber substrate becomes difficult to be distinguished by discoloration of the fiber substrate through adsorption of a smelling gas.

3. An odor eliminating fiber structure having an indicator as claimed in claim 2, wherein a color difference between the color of the fiber substrate upon losing the odor eliminating power and the color of the standard color display part provided on the surface of the fiber substrate is 4 or more grades upon evaluation with gray scale for assessing change in color.

4. An odor eliminating fiber structure having an indicator as claimed in one of claims 1 to 3, wherein the odor eliminating fibers contain at least one odor eliminating component selected from silver, copper and a metallic compound thereof, and a content of silver and/or copper is 0.1% by weight or more of the total fiber substrate.

5. An odor eliminating fiber structure having an indicator as claimed in one of claims 1 to 4, wherein the odor eliminating fibers comprises an odor eliminating component-containing crosslinked acrylate fibers containing at least one odor eliminating component selected from silver, copper and a metallic compound thereof, and content of a silver and/or copper is 0.1% by weight or more of the total acrylate fibers.

6. An odor eliminating fiber structure having an indicator as claimed in one of claims 1 to 5, wherein one surface of the fiber substrate has an easy-sticking and easy-releasing function.
